(19) United States
(12) Patent Application Publication
(10) Pub. No.: US 2013/0069757 A1
(43) Pub. Date: Mar. 21, 2013

(54) MULTILAYERED INDUCTOR AND METHOD OF MANUFACTURING THE SAME

(71) Applicant: Kwang Sun CHOI, Busan (KR)

(72) Inventor: Kwang Sun CHOI, Busan (KR)

(73) Assignee: SAMSUNG ELECTRO-MECHANICS CO., LTD.

(21) Appl. No.: 13/613,319

(22) Filed: Sep. 13, 2012

(30) Foreign Application Priority Data
Sep. 19, 2011 (KR) 10-2011-0094141

(51) Int. Cl. H01F 27/36; H01F 41/00

(52) U.S. Cl. 336/84 R; 29/602.1

(57) ABSTRACT

Disclosed herein is a multilayered inductor including: a multilayered body in which a plurality of body sheets are multilayered; a coil part configured of internal electrode patterns formed on the body sheets; a magnetic path shielding part formed in a vertical direction so as to be adjacent to the coil part and made of a non-magnetic material; and external electrodes formed at both sides of the multilayered body and electrically connected to both ends of the coil part. Therefore, even though the number of non-magnetic materials is increased, the closed magnetic path structure is maintained, thereby making it possible to easily implement the inductance. In addition, the multilayered numbers of the internal electrode patterns configuring the coil part are decreased, such that a region in which the coil part is not present in the multilayered inductor is increased, thereby making it possible to improve the DC bias characteristics.

### CROSS REFERENCE(S) TO RELATED APPLICATIONS

This application claims the benefit under 35 U.S.C. Section 119 of Korean Patent Application Serial No. 10-2011-0094141, entitled “Multilayered Inductor and Method of Manufacturing the Same” filed on Sep. 19, 2011, which is hereby incorporated by reference in its entirety into this application.

### BACKGROUND OF THE INVENTION

1. Technical Field

The present invention relates to an inductor, and more particularly, to a multilayered inductor having a coil part in which a plurality of body sheets having printed internal electrodes are multilayered, and a method of manufacturing the same.

2. Description of the Related Art

A multilayered inductor has been mainly used for a power supply circuit such as a direct-current (DC)—direct-current (DC) converter in a portable device, and developed for miniaturization, high current, low DC resistance, or the like. In accordance with the current trend for a DC-DC converter having a high frequency and a small size, the use of the multilayered inductor has increased instead of the existing wound coil.

The multilayered inductor is configured of a multilayered body in which magnetic parts having a plurality of multilayered layers and non-magnetic layers inserted in the magnetic parts are complex, and has an internal coil made of a conductive metal in the magnetic part or the non-magnetic layer, and punching holes in each layer in order to connect the plurality of layers to each other.

In general, a magnetic material used in the multilayered inductor is made of ferrite containing Ni, Zn, Cu, or the like, and a non-magnetic material is generally made of ferrite containing Zn, Cu, or a glass containing Zr, or TiO₃, SiO₂, Al₂O₃, and the like.

In the multilayered inductor as described above, a decrease in inductance (a decrease in DC bias characteristics) is generated by magnetic saturation of the magnetic material according to an increase in a current. In order to solve this problem, the non-magnetic materials are inserted in a horizontal direction which is the same as a direction in which magnetic materials are multilayered to thereby improve DC bias characteristics.

Meanwhile, in a method in which the non-magnetic materials are inserted in a horizontal direction, it is difficult to implement high inductance due to a structure of an open magnetic path. In order to solve this problem, an internal coil in which a conductive metal is printed therein needs to be increased. However, since this method causes an increase in the DC resistance, it is difficult to apply this method.

In addition, in order to implement high DC bias characteristics, the number of non-magnetic materials including or not including the internal coil in which the conductive metal is printed therein needs to be increased. However, it is difficult to implement the inductance due to the structure of the open magnetic path according to an increase in a non-magnetic material, such that it is difficult to increase the non-magnetic material.

### SUMMARY OF THE INVENTION

An object of the present invention is to provide a multilayered inductor capable of having improved direct-current bias characteristics by inserting a non-magnetic material into the multilayered inductor in a vertical direction, and a method of manufacturing the same.

According to an exemplary embodiment of the present invention, there is provided a multilayered inductor including: a multilayered body in which a plurality of body sheets are multilayered; a coil part configured of internal electrode patterns formed on the body sheets; a magnetic path shielding part formed in a vertical direction so as to be adjacent to the coil part and made of a non-magnetic material; and external electrodes formed at both sides of the multilayered body and electrically connected to both ends of the coil part, respectively.

The magnetic path shielding part may be formed in any one of the inner side and the outer side of the coil part, and a plurality of magnetic path shielding parts may be overlapped with each other.

According to another exemplary embodiment of the present invention, there is provided a method of manufacturing a multilayered inductor, the method including: forming magnetic path shielding parts in body sheets; forming internal electrode patterns on the body sheets; forming the magnetic path shielding parts around the internal electrode patterns; multilayering the plurality of body sheets; and forming external terminals on both sides of the multilayered body sheets.

The magnetic path shielding parts may be formed by inserting non-magnetic components, or be formed by printing non-magnetic paste.

The method may further include: compressing the multilayered body sheets, before the forming of the external terminals.

### BRIEF DESCRIPTION OF THE DRAWINGS

FIG. 1 is a perspective view of a multilayered inductor according to an exemplary embodiment of the present invention;

FIG. 2 is a cross-sectional view taken along the line I-I′ of FIG. 1;

FIG. 3 is a cross-sectional view of a multilayered inductor according to a second exemplary embodiment of the present invention;

FIG. 4 is a cross-sectional view of a multilayered inductor according to a third exemplary embodiment of the present invention;

FIG. 5 is a cross-sectional view of a multilayered inductor according to a fourth exemplary embodiment of the present invention;

FIG. 6 is a view showing a process of manufacturing a multilayered inductor according to the present invention; and

FIGS. 7 to 9 are graphs showing characteristics of the multilayered inductor according to the present invention.

### DESCRIPTION OF THE PREFERRED EMBODIMENTS

Hereinafter, exemplary embodiments of the present invention will be described in detail with reference to the accompanying drawings. However, this is only by way of example and therefore, the present invention is not limited thereto.

When technical configurations known in the related art are considered to make the contents obscure in the present invention, the detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

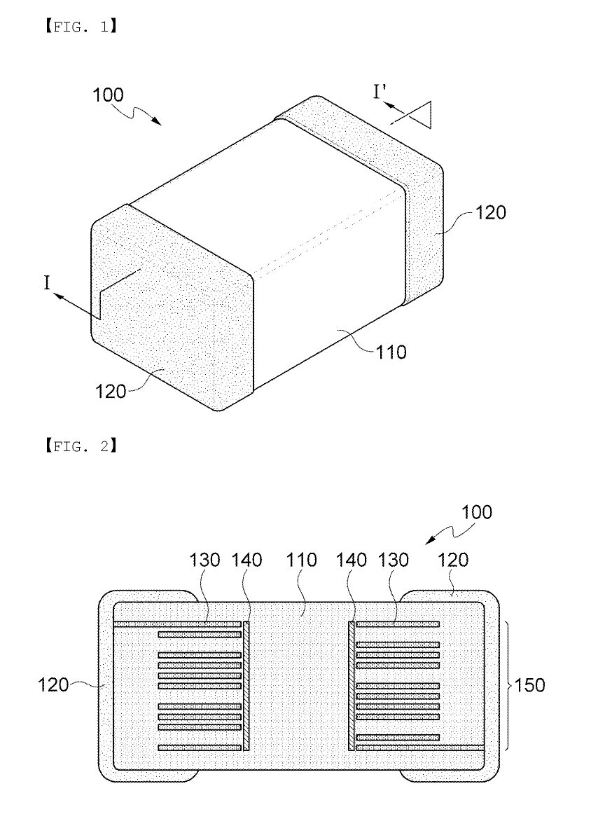

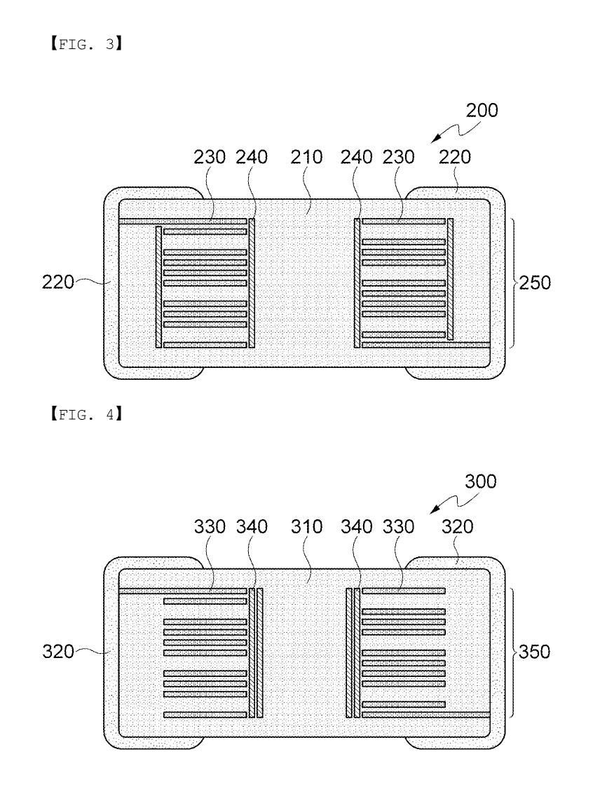

FIG. 1 is a perspective view of a multilayered inductor 100 according to the present invention; and FIG. 2 is a cross-sectional view taken along the line I-I′ of FIG. 1. Referring to FIGS. 1 and 2, the multilayered inductor 100 according to the present invention may include a multilayered body 110, a coil part 150, magnetic path shielding parts 140, and external electrodes 120.

The multilayered body 110 is formed by multilayering body sheets 115 made of a ferrite material in several layers. In general, the ferrite, which is a material such as ceramic having magnetic properties, has high transmittance and high electrical resistance to a magnetic field, such that it is used for various kinds of electronic components.

The body sheets 115 are formed in a thin plate shape, and have internal electrode patterns 130 formed on upper surfaces thereof. Several body sheets 115 are multilayered to vertically combine the internal electrode patterns 130 with each other, thereby forming a coil part 150.

In addition, external electrodes 120 are positioned at both sides of the multilayered body 110, and are electrically connected to both ends of the coil part. The coil part 150 positioned in the multilayered body 110 is electrically connected to the outside through the external electrodes 120.

Meanwhile, the magnetic path shielding parts 140 are formed in a vertical direction, so as to be adjacent to the coil part 150. The magnetic path shielding parts 140 are made of a non-magnetic material and formed in a vertical direction, such that the multilayered inductor 100 of the present invention has a closed magnetic path structure.

In particular, the multilayered inductor 100 of the present invention has the magnetic path shielding parts 140 formed in a vertical direction, such that even though the number of magnetic path shielding parts 140 which are non-magnetic materials is increased, the closed magnetic path structure may be maintained, thereby easily implementing the inductance and the high DC bias characteristics.

In addition, the multilayered number of the internal electrode patterns 130 configuring the coil part 150 may be decreased, such that a region in which the coil part 150 is not present is increased in the multilayered inductor, thereby making it possible to improve the DC bias characteristics.

FIGS. 3 to 5 are cross-sectional views of multilayered inductors according to second to fourth exemplary embodiments of the present invention. Other exemplary embodiments of the present invention will be described with reference to FIGS. 3 to 5.

FIG. 3 is a cross-sectional view of a multilayered inductor 200 according to a second exemplary embodiment of the present invention. As shown in FIG. 3, magnetic path shielding parts 240 may be formed at an inner side and an outer side of a coil part 250.

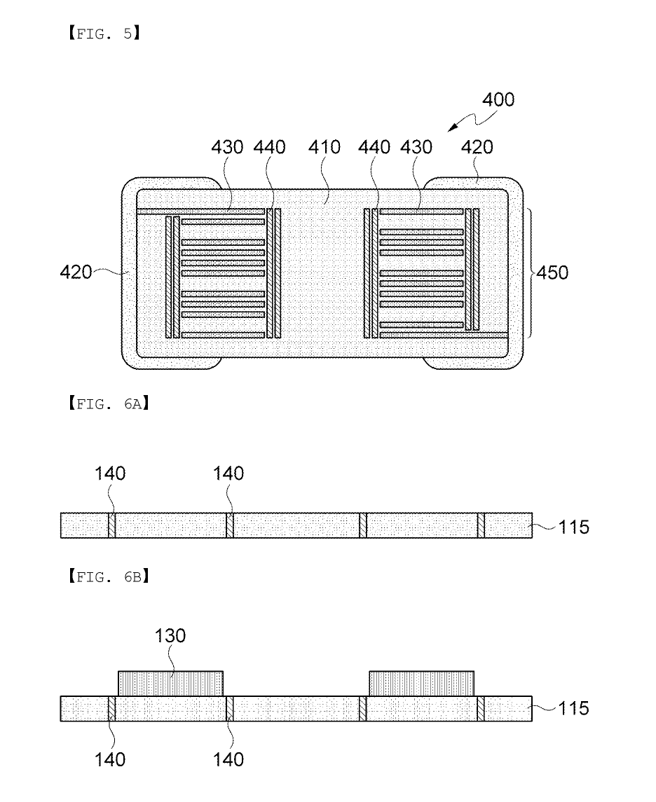

FIG. 4 is a cross-sectional view of a multilayered inductor 300 according to a third exemplary embodiment of the present invention. As shown in FIG. 4, magnetic path shielding parts 340 may be formed at an inner side of a coil part 350 and, particularly, may be formed by being overlapped to each other in double.

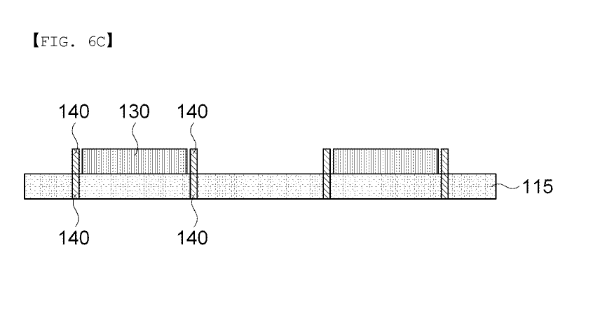

FIG. 5 is a cross-sectional view of a multilayered inductor 400 according to a fourth exemplary embodiment of the present invention. As shown in FIG. 5, magnetic path shielding parts 440 may be formed at an inner side and an outer side of a coil part 450 and, particularly, may be formed by being overlapped with each other in double.

Although the present invention describes the case in which the magnetic path shielding parts 340 and 440 are overlapped with each other, it is described by way of example only. Therefore, the magnetic path shielding parts 340 and 440 may also be overlapped with each other in triple, quadruple, or more.

In addition, although FIGS. 2 to 5 show the case in which the magnetic path shielding parts 140, 240, 340, and 440 are formed at inner sides of the coil parts 150, 250, 350, and 450, or at inner sides and outer sides thereof, they may also be formed at only outer sides of the coil parts 150, 250, 350, and 450.

As described above, the magnetic path shielding parts 140 are formed by being overlapped with each other to increase the number of non-magnetic material, thereby significantly improving the DC bias characteristics.

Hereinafter, a method of manufacturing a multilayered inductor according to the present invention will be described.

FIG. 6 is a view showing a process of manufacturing a multilayered inductor according to the present invention. As shown in FIG. 6, the body sheets 115 made of a ferrite material are first prepared, and then the magnetic path shielding parts 140 are formed in the body sheets 115. As described above, the magnetic path shielding parts 140 are made of a non-magnetic material.

In addition, as shown in FIG. 6B, the internal electrode patterns 130 are formed on upper surfaces of the body sheets 115. Then, as shown in FIG. 6C, the magnetic path shielding parts 140 are formed on upper surfaces of the body sheets 115.

In addition, as shown in FIG. 6D, the plurality of body sheets 115 having the internal electrode patterns 130 and the magnetic path shielding parts 140 formed therein are multilayered. As described above, the body sheets 115 are multilayered, such that the magnetic path shielding parts 140 are vertically combined with each other and formed in a vertical direction.

Finally, external terminals are formed at both sides of the multilayered body sheets 115, such that the multilayered inductor 100 according to the present invention is completed.

Meanwhile, the magnetic path shielding parts 140 may be formed by removing portions at which the magnetic path shielding parts 140 are to be formed in the body sheets 115, and then inserting the magnetic path shielding parts 140 into the removed portions.

In addition, the magnetic path shielding parts 140 may be formed by forming punching holes on the body sheets 115 and printing a non-magnetic paste thereon.

The method of manufacturing the multilayered inductor according to the present invention may further include compressing the multilayered body sheets 115, before the forming of the external terminals. The multilayered body sheets 115 are compressed, such that the internal electrode patterns 130 and the magnetic path shielding parts 140 are sealed by the body sheets 115 positioned in upper and lower portions.

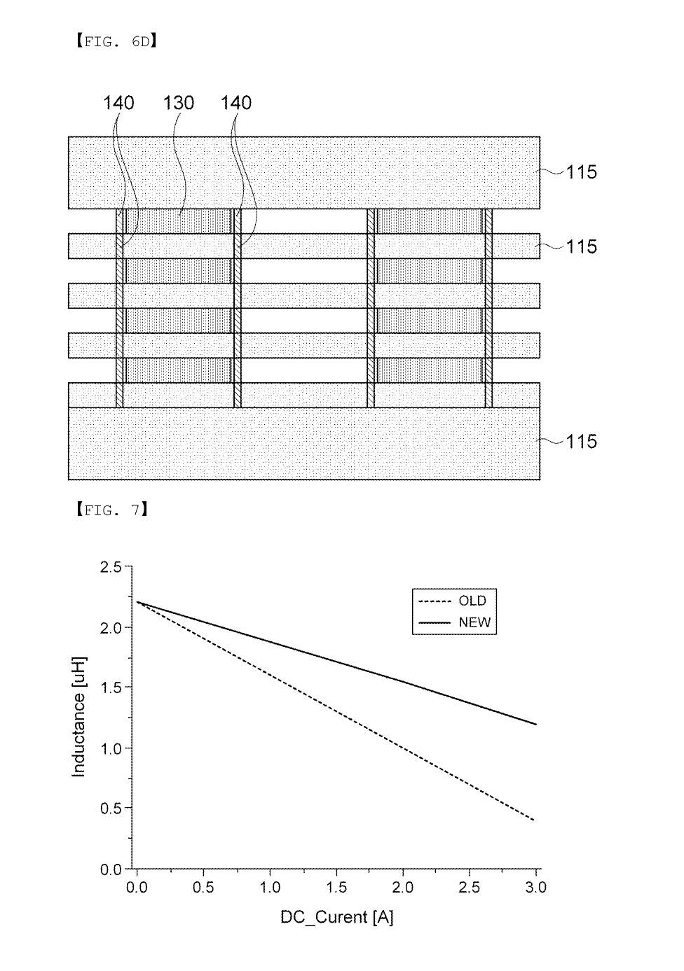

Hereinafter, characteristics of the multilayered inductor according to the present invention will be described with reference to FIGS. 7 to 9. FIGS. 7 to 9 are graphs showing the comparison result of characteristics of a multilayered inductor of the related art in which existing non-magnetic materials (magnetic path shielding parts) are inserted in a horizontal direction and a multilayered inductor of the present invention in which non-magnetic materials (magnetic path shielding parts) are inserted in a vertical direction.

In FIG. 7, a dotted line (OLD) is a graph showing characteristics of the multilayered inductor of the related art in which the non-magnetic materials are inserted in a horizontal direction. In this case, the multilayered inductor includes seven layers of internal electrodes and two sheets of non-magnetic materials inserted therein to thereby implement 2.2 μH. In addition, a solid line (NEW) in FIG. 7 is a graph showing characteristics of the multilayered inductor of the present invention. In this case, the multilayered inductor includes five layers of internal electrodes and four sheets of non-magnetic materials inserted in a vertical direction therein to thereby implement 2.2 μH.

It may be appreciated from the graph shown in FIG. 7 that when considering a change in an inductance according to an increase in a DC current, the multilayered inductor (indicated as the solid line) of the present invention has a change in an inductance significantly smaller than that of the multilayered inductor (indicated as the dotted line) of the related art.

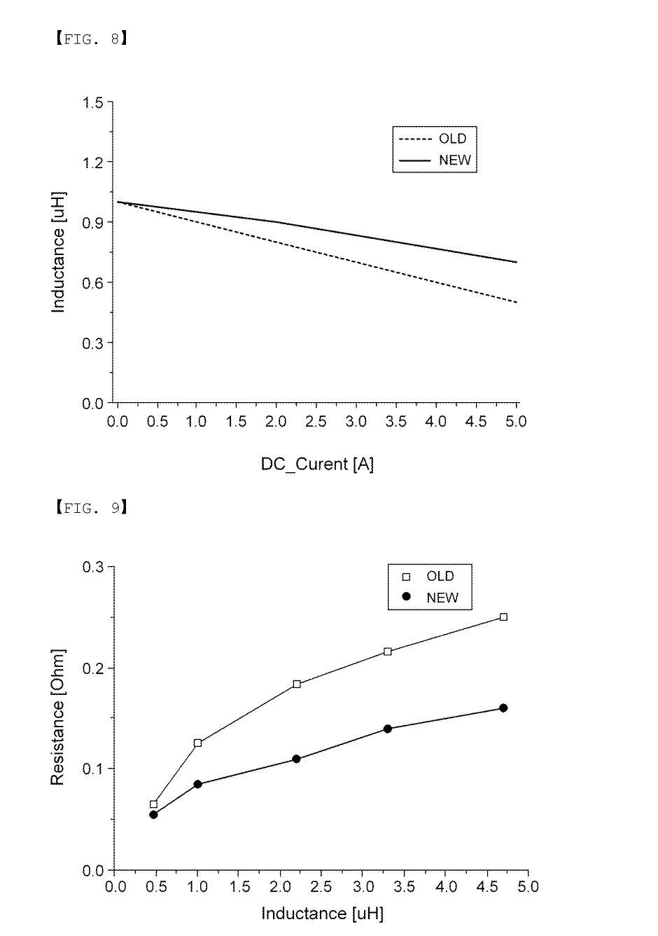

In FIG. 8, a dotted line (OLD) is a graph showing characteristics of the multilayered inductor in which seven internal electrodes and one non-magnetic material inserted in a horizontal direction therein, to thereby implement 1.0 μH, and a solid line (NEW) is a graph showing the characteristics of the multilayered inductor of the present invention, which includes five layers of internal electrodes and two sheets of non-magnetic material inserted in a vertical direction therein to thereby implement 1.0 μH.

As similar to FIG. 7, it may be appreciated from FIG. 8 that in the multilayered inductor (indicated as the solid line) of the present invention, a change in an inductance according to an increase in the DC current is significantly smaller as compared to that of the multilayered inductor (indicated as the dotted line) of the related art.

FIG. 9 is a graph showing DC resistance characteristics according to an inductance. The multilayered inductor (NEW) of the present invention has smaller multilayered number of the internal electrodes and has the same inductance as compared to the multilayered inductor (OLD) of the related art. Therefore, it may be appreciated from FIG. 9 that the multilayered inductor (NEW) of the present invention has a low DC resistance in the same inductance as the multilayered inductor (OLD) of the related art.

As set forth above, according to the multilayered inductor and the method of manufacturing the same of the present invention, the non-magnetic materials are inserted in a vertical direction, such that even though the number of non-magnetic materials is increased, the closed magnetic path structure is maintained, thereby making it possible to easily implement the inductance and the high DC bias characteristics.

In addition, the multilayered numbers of the internal electrode patterns configuring the coil part are decreased, such that a region in which the coil part is not present in the multilayered inductor is increased, thereby making it possible to improve the DC bias characteristics.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A multilayered inductor comprising:
a multilayered body in which a plurality of body sheets are multilayered;
a coil part configured of internal electrode patterns formed on the body sheets;
a magnetic path shielding part formed in a vertical direction so as to be adjacent to the coil part and made of a non-magnetic material; and
external electrodes formed at both sides of the multilayered body and electrically connected to both ends of the coil part, respectively.

2. The multilayered inductor according to claim 1, wherein the magnetic path shielding part is formed in any one of the inner side and the outer side of the coil part.

3. The multilayered inductor according to claim 2, wherein a plurality of magnetic path shielding parts are overlapped with each other.

4. A method of manufacturing a multilayered inductor, the method comprising:
forming magnetic path shielding parts in body sheets;
forming internal electrode patterns on the body sheets;
forming the magnetic path shielding parts around the internal electrode patterns;
multilayering the plurality of body sheets; and
forming external terminals on both sides of the multilayered body sheets.

5. The method according to claim 4, wherein the magnetic path shielding parts are formed by inserting non-magnetic components.

6. The method according to claim 5, wherein the magnetic path shielding parts are formed by printing non-magnetic paste.

7. The method according to claim 5, further comprising:
compressing the multilayered body sheets before the forming of the external terminals.
